(19) United States
(12) Patent Application Publication
(10) Pub. No.: US 2003/0066241 A1
(43) Pub. Date: Apr. 10, 2003

(54) Multidirectional frame provided with a heat sensor

(76) Inventor: Jacques Lambey, Lyon (FR)

Correspondence Address: HESLIN ROTHENBERG FARLEY & MESITI PC, 5 COLUMBIA CIRCLE, ALBANY, NY, 12203, US

(21) Appl. No.: 10/294,871

(22) Filed: Nov. 14, 2002

Related U.S. Application Data
(63) Continuation of application No. PCT/FR01/01514, filed on May 17, 2001.

(30) Foreign Application Priority Data
May 17, 2000 (FR) FR 00.06263

(51) Int. Cl. E06B 7/08

(52) U.S. Cl. 49/64

(57) ABSTRACT

The invention is relative to a frame able to receive, on at least one of its two main faces, a heat sensor characterized in that said frame said frame can be oriented in a continuously progressing range or in a stepping mode with respect to the illumination of the sun.

The invention relates to the technical field of equipping individual and communal dwellings and more specifically to that of collecting energy, particularly of solar origin.

It thus relates to an orientable frame able to receive a heat sensor, and the orientation of which is dependent on the both daily and seasonal course of the sun.

In the context of the production of electrical and thermal energy, the use of panels is, these days, widely known. These panels are traditionally incorporated into a roof structure or even placed on the ground. As a result, they have a constant inclination, admittedly sometimes optimized, with respect to the illumination of the sun. In consequence, depending on the time of day and season considered, these panels are far from developing the nominal efficiencies for which they were designed.

Studies carried out have demonstrated that such a panel needed to have a mean inclination with respect to the vertical of 30° in the winter and 60° in the summer. As a result, panels have been produced which allow this double inclination. However, this double inclination operates on the all-or-nothing principle, that is to say that there are no intermediate positions between these two extreme positions, nor are there any progressions. In consequence, while the energy efficiency is admittedly improved, it is a long way from being optimized.

The objective of the invention is to allow optimization of this collection of energy, by simple accumulation of heat.

To this end, the invention proposes a frame able to receive, on at least one of its two main faces, a heat sensor, characterized in that said frame can be oriented in a continuously progressing range or in a stepping mode with respect to the illumination of the sun, this orientation is achieved by means of an automatically actuated member.

The stepwise progression, for typical periods of about ten minutes, thus makes it possible to take the course of the sun into consideration without in any way needing a mechanism that is relatively tricky to optimize in order to ensure progression in continuous mode in synchronism with said course of the sun.

The actuating member may consist of an electric ram acting directly on the frame or via scissors stays, particularly symmetric ones of which one of the branches is secured to the frame, in this case articulated to one of its sides on a support structure, and the other is secured to the support structure, to which said frame is articulated.

The frame in question may furthermore is translated linearly and to be used as a sliding, oscillo-casement shutter or oscillo-sliding shutter, so as also to perform the functions of traditionally blocking out light from the dwelling to which it is fitted.

The frame may also be employed in solar cover devices for swimming pools and other basins.

The way in which the invention may be achieved and its ensuing advantages will become better apparent from the exemplary embodiments which follow, given by way of nonlimiting indication with reference to the appended figures.

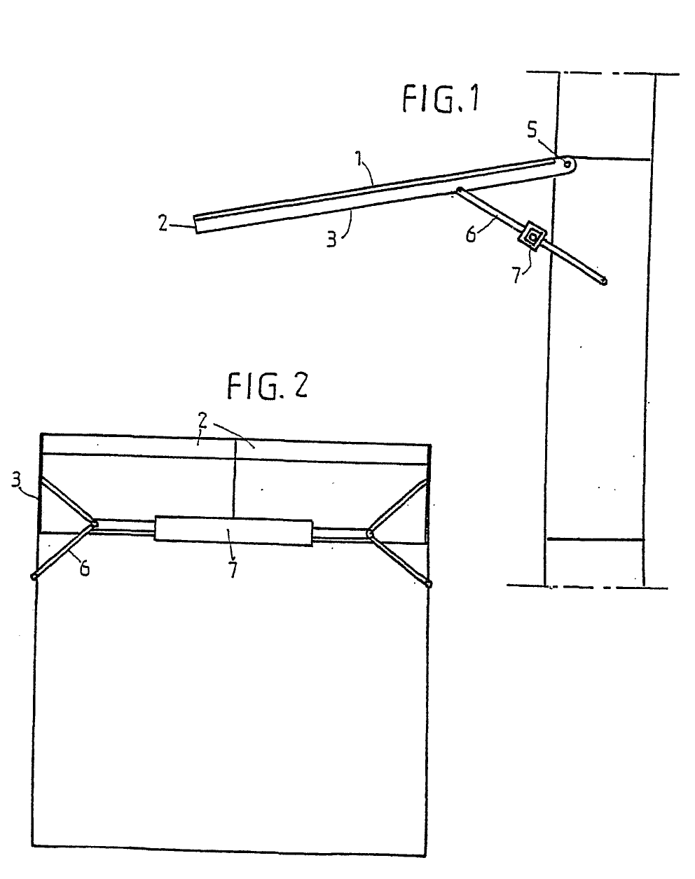

FIG. 1 is a schematic depiction in side view of an articulated orientable frame according to the invention.

FIG. 2 is a front view of the frame in question, according to one of the embodiments of the invention.

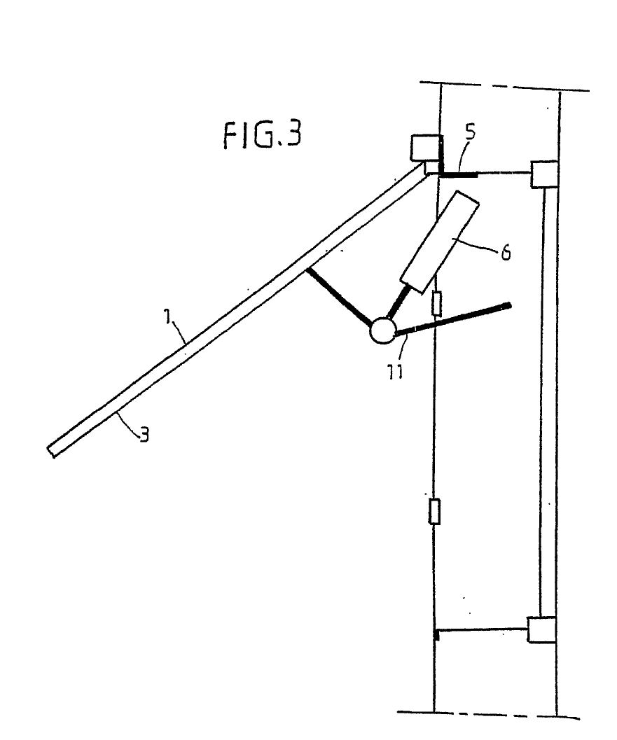

FIG. 3 is a schematic depiction of a pivoting frame, acting as a shutter, and constituting an alternative form of FIG. 1.

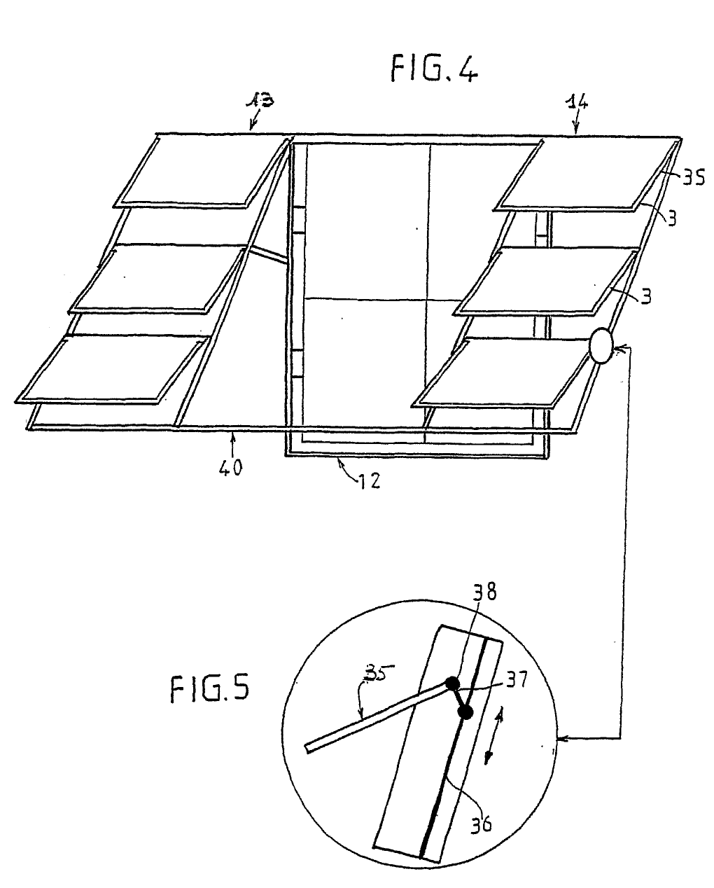

FIG. 4 is a schematic perspective depiction of another embodiment of the invention, employing a frame for an oscillo-casement shutter, in the open position, of which FIG. 5 is a detail view of the mechanism for operating the constituent elemental leaves.

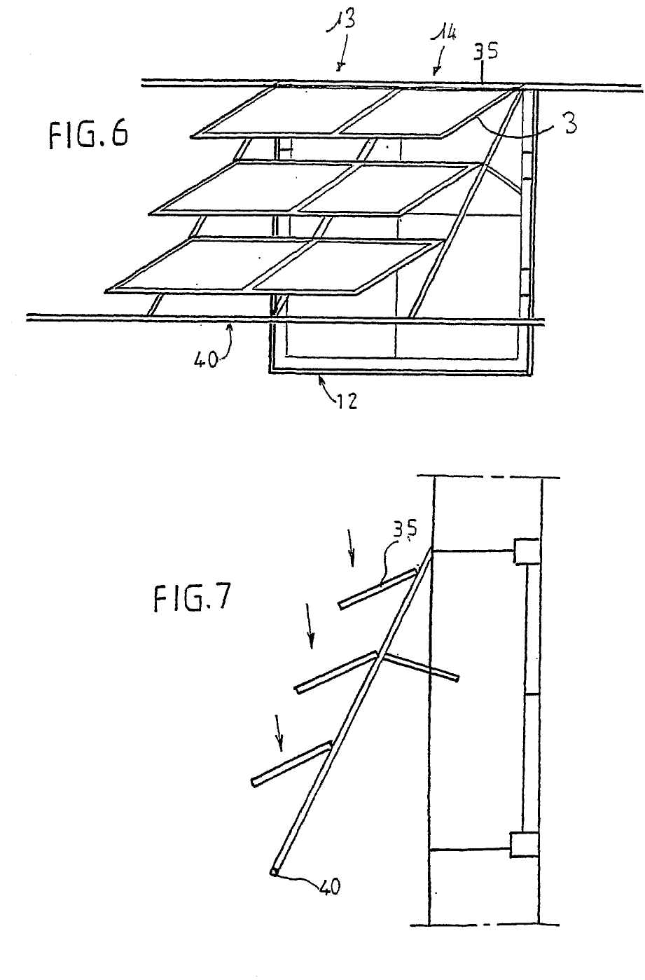

FIG. 6 is a view similar to FIG. 4, but depicted in the semi-closed position.

FIG. 7 is a side view of FIG. 6.

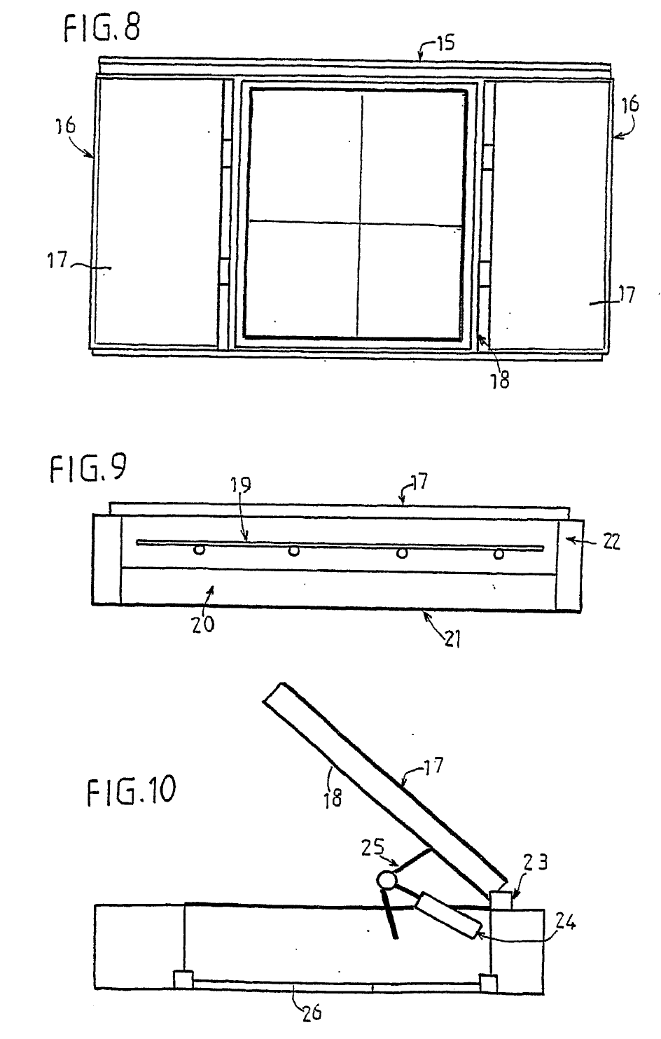

FIG. 8 is a sectional view of a frame equipped with a heat sensor.

FIG. 9 is a detail view of such a heat sensor.

FIG. 10 is a side view of the oscillo-casement shutter equipped with such a heat sensor.

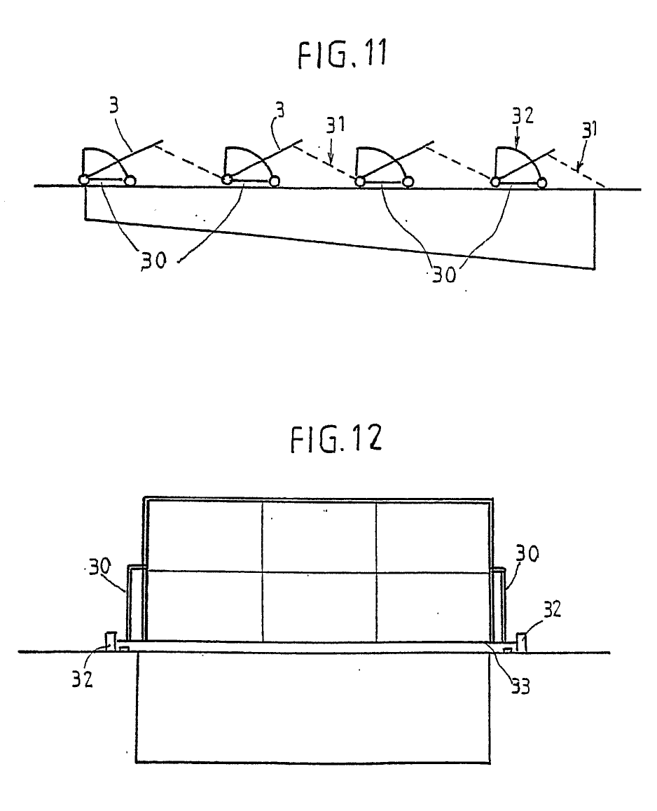

FIG. 11 is a schematic depiction of several frames according to the invention, equipped with heat sensors associated with each other and constituting a cover assembly, particularly for swimming pools or basins.

FIG. 12 is a view of the sensor in a roughly vertical position.

As already specified, the invention relates more specifically to communal or individual dwellings and is particularly intended to be implemented, in a first embodiment, in shutters, equipped with heat sensors.

In the case of these shutters, there are various simple or double, manually opened or motor-assisted systems in existence. Among the various types of model available, oscillo-shutters, oscillo-casement shutters and oscillo-sliding shutters are known, it being possible for all of these to be simple or double manually opened and/or tilted or motor-assisted. As a result, various combinations may be imagined, without there being any need to go into detail here.

The shutter (2) according to the invention therefore comprises an orientable frame (3) and, in this case, one that is articulated at a window by a horizontal axis of articulation (5). This frame (3) receives on its top face a heat sensor (1) stretching over practically its entire surface.

According to the invention, the sensor (1) is secured to the frame (3) by any means, particularly a resin, or any traditional mechanical fixing or bonding system.

A shutter of the casement type is able to receive a module on each of its two faces, so as to receive radiation when open and when closed. The shutter may be made of any material, particularly of wood, composite such as synthetic resin, PVC, or even metal.

Associated with this shutter is an orientation or inclination member intended to maintain an angle of roughly 90° between the surface of the heat sensor that it receives and the solar radiation, bearing in mind the daily and seasonal illumination.

This member is either manual or motorized. To this end, the shutter, as already stated, is secured to the frame (3), particularly made of metal. The frame is mounted on pivots (5) or an axis of articulation, secured in particular to the wall of the reveal of the window considered. Furthermore, two symmetric scissors stays (6) connect the frame to the wall, as can well be seen in FIGS. 1 and 2. These scissors stays are actuated by means of a ram (7), particularly an electric ram, in such a way as to cause the frame (3) to move away from, or, on the other hand, toward, the wall and to do so continuously or in a stepping mode. In the latter instance, an appropriate motor causes the frame to move, for example every ten minutes.

When large-sized double shutters are used, each scissors stay is actuated by electric rams (7) which are placed vertically on each side of the window reveal (this embodiment is not depicted). The two rams act simultaneously on scissors stays which deploy under the effect of pressure. The electric rams may be controlled by a programmed clock. They thus allow the shutters to be raised easily during the course of the day and kept roughly in a plane oriented at 90° with respect to the solar radiation. As a side issue, these rams close them at the end of the day.

In the case of simple shutters, just one electric ram is sufficient and this acts on the two scissors stays simultaneously. It is then oriented roughly horizontally, at the top of the reveal, as will become apparent incidentally from FIGS. 1 and 2.

An alternative form of embodiment to the one already described has been depicted in conjunction with FIG. 3. In this alternative form, the opening or closure of the frame (3) is effected via an electric ram (10) acting on an axis of articulation (8) from which there extend two axes (9, 11) toward the frame and toward the window, respectively. The axes (9, 11) are themselves articulated to the place where the window is secured to the frame.

In another embodiment depicted in conjunction with FIGS. 4 to 7, use is made of oscillo-casement shutters able to slide at the upper edge of the window in question. A metal frame (12), the same size as the reveal of the window, is installed on the existing hinge pins. This frame (12) receives a support frame (40) of the pivoting oscillo type equipped with two photo-generating shutters of the casement type (13, 14). Each of these two shutters is in fact made up of one or more rows of solar modules or leaves (35), each mounted on an orientable frame (3) and controlled simultaneously particularly by an electric ram or by a micromotor controlled by a clock.

Thus, the support (40) is inclined manually in the manner of venetian blinds, whereas the modules are oriented automatically, continuously or in stepping mode, as in the previous embodiment, by the ram or the micromotor, for example acting on a chain (36) on which lever arms (37) are mounted, these lever arms themselves acting on the leaves (35) via an axis of articulation (38) (see FIG. 5).

FIG. 6 depicts the shutters in the closed position. For this, the frames bearing the modules (35) slide at the upper edge of the frame (12).

By virtue of these various shutters equipped therefore with panels the orientations of which are automated, high electrical-energy production efficiencies can be achieved while at the same time maintaining the functionality of the shutters. Advantageously, the hourly range for the programming of the inclination is, in France, between 10 h and 16 h, that is to say the period which receives about 90% of the daily radiation.

The mean value of the overall radiation received during a day with discontinuous sunshine by programmed oscillo-shutters according to the invention is about twice as high as that of a fixed module inclined at 60°, with respect to the vertical, which is the average inclination of a roof structure.

Thus, the pivoting oscillo-system according to the invention makes it possible to practically double the efficiency for the same surface area. Such a system also proves to be suited to mountainous regions where snow covers roofs for a good proportion of the winter, although the level of solar radiation is high. This system can also be produced easily and gives rise to relatively low costs. Furthermore, each of the modules can be incorporated into any building, without generating additional weatherproofing costs. Finally, such modules are readily accessible and simple to maintain.

In another embodiment depicted in detail in conjunction with FIGS. 8 to 10, it has been illustrated another form of the invention with use of a heat sensor as well. The objective is to use the heat energy developed by the sun of daily exposure. Each of the heat sensors, depicted in greater detail in FIG. 9, is made up of a metal casing (21), for example made of galvanized steel or aluminum-based alloy, lined internally with a thermal insulator (20), typically consisting of polyurethane foam. This casing (21) has a heat absorber (19) made of copper welded to a copper tube about 8 mm in diameter, and through which a heat-transfer fluid flows. A tempered glass panel (17) covers the casing (21).

In the closed position, the shutter equipped with such a heat sensor closes off the window, in the manner of conventional shutters, and present to the outside the rear face of the casing which may receive a material or a color suited to the shade of the building. The casement shutters are opened manually, pivoting them on their hinges. The heat sensors are then exposed to the light of the sun. To increase their efficiency, all that is required is for the pivoting oscillo-frame (16) to be pushed manually or electrically so that it can adopt an inclination of close to 45° C. The temperature of the heat-transfer fluid flowing through the tubes (19) then rises under the effect of the solar radiation, and the heat is stored in the casing (21).

The heat-transfer fluid flowing through the tubes (19) carries the stored heat energy to a domestic hot water tank in the dwelling or to a heating circuit. The principle always remains the same as far as the varying of the inclination of the shutters so equipped is concerned. The opening and especially the pivoting of the shutters are motorized in order to present a programmable orientation that is dependent on the level of sunshine. In the same way as before, the goal is to maintain the orientation of the glazed panel (17) roughly perpendicular to the direction of the solar radiation so as to accumulate the maximum amount of thermal solar energy.

This embodiment is depicted in greater detail in conjunction with FIG. 10. The metal frame (18) is articulated at (23) at the reveal of the window (26). An electric ram (24) actuates a scissors stay (25) on the command of an incorporated or some other clock (not depicted). One of the branches of said scissors stay is fixed to the wall, while the other is secured to the oscillo frame (18).

These shutters combine three functions:

closing off the windows or the glazed apertures;

producing during the daytime from 30 to 70% of the hot water for a dwelling, depending on the regional level of sunshine;

thermally insulating the windows, the losses from which are high, particularly by night.

In another embodiment of the invention which is depicted in greater detail in conjunction with FIGS. 11 and 12, the frame according to the invention is intended to be implemented in a cover for a swimming pool or basin. Such covers are generally employed so as to concentrate the heat emitted by the sun into the water, and thus raise the temperature thereof, aside from limiting heat losses by night.

According to the invention, this cover is equipped with a number of heat solar sensors mounted on pivoting oscillo-frames, themselves mounted on carriages able to allow the frames to move and to be arranged over the swimming pool. These carriages (30) can therefore be moved on each side of the basin.

Thus, the heat sensors secured to the frame, in the manner already described, absorb the heat of the solar radiation and transmit it to a heat-transfer fluid situated at the bottom of the swimming pool, or even to the water of a domestic hot water tank, or alternatively still to the heating circuit of a dwelling.

Each of the frames (3), mounted on a carriage (30) that can move on rollers (32), is connected by a flexible and removable canvass (31) connecting the frame of one carriage to the next carriage so as to give a certain degree of continuity to the cover thus produced. The frames (3), receiving a heat sensor on its upper face, is able to be inclined continuously or in stepping mode by means of specific members of the kind already described, so as to receive the maximum solar radiation, the course of this inclination being advantageously motorized, in the manner indicated earlier.

Depending on the size of the module, the latter is inclined manually or electrically either by a ram which pulls it or by a motor which drives a chain secured to the sensor. The efficiency of the modules is improved by programming the inclination, which causes the module to be oriented always perpendicular to the solar radiation.

To perfectly cover the swimming pool, all of the sensors are placed horizontally, the carriages being as a result aligned along the length of the basin. They can also act as a guard rail. Depending on the programming, the sensors stand up during the course of the day to follow the course of the sun. As a side issue, the canvasses (31) situated between each sensor or module protect the basin.

With such heat sensors installed at the frames (3), the temperature of the heat-transfer fluid rises under the effect of the solar radiation and of the heat stored in the casing (higher than 100° C. in the summer). The heat-transfer fluid flows and transports the stored heat energy to the water of the basin or the domestic hot water tank of the dwelling or to a heating circuit. It has been demonstrated that 10 m² of sensors supply between 50 to 70% of the hot water requirements of a dwelling.

When the swimming pool is in use, this cover has to be taken off. For this, each sensor is positioned in a position close to the vertical. Then the carriages (30) are moved, starting with the last one, a guide fixed to the ground on each side of the basin keeping the wheels parallel to the basin, in the manner of rails, so that the carriages remain parallel. A difference in length allows them to be nested together and thus occupy a minimum amount of space at the end of the basin.

The entire benefit of the device according to the invention in the context of seeking to optimize the use of solar energy can thus be appreciated, which energy is free and makes it possible to limit the release of polluting gases, which are the cause of the greenhouse effect and of its consequences.

This device is of an easy design and, given its ease of adaptation to existing supports, proves to be entirely advantageous in terms of energy saving.

1. A frame able to receive, on at least one of its two main faces, a heat sensor, said frame can be oriented with respect to the illumination of the sun, characterized in that
said frame can be oriented in a continuously progressing range or in a stepping mode;
its orientation is achieved by means of an automatically actuated member, constiting of at least one electric ram;
and in that the frame is able to be translated linearly and to be used as a sliding, oscillo-casement shutter, or oscillo-sliding shutter, so as also to perform the functions of traditionally blocking out light from the dwelling to which it is fitted.

2. The frame as claimed in claim 1, characterized in that the actuating member of the orientation acts directly on the frame or via scissors stays, particularly symmetric ones of which one of the branches is secured to the frame, in this case articulated to one of its sides on a support structure, to which said frame is articulated.

3. The frame as claimed in any of claims 1 and 2, characterized in that it is integrated in multiples panels, each of said panel having an orientable frame.
